(19) United States
(12) Patent Application Publication
(10) Pub. No.: US 2012/0095133 A1
(43) Pub. Date: Apr. 19, 2012

(54) CORE/SHELL RUBBERS FOR USE IN ELECTRICAL LAMINATE COMPOSITIONS

(75) Inventors: Kamesh R. Vyakaranam, Pearland, TX (US); Lameck Banda, Manvel, TX (US); Michael J. Mullins, Houston, TX (US); Marvin L. Dettloff, Lake Jackson, TX (US); Jacob W. Strother, Sweeny, TX (US)

(73) Assignee: Dow Global Technologies LLC, Midland, MI (US)

(21) Appl. No.: 13/320,560

(22) PCT Filed: Jul. 8, 2010
(86) PCT No.: PCT/US10/41311

§ 371 Date: Nov. 15, 2011

Related U.S. Application Data
(60) Provisional application No. 61/224,572, filed on Jul. 10, 2009.

(51) Int. Cl. C08L 83/10; C09J 163/00; C09J 183/10; C09D 163/00; C08L 63/00; C09D 183/10

(52) U.S. Cl. 523/435; 525/101

(57) ABSTRACT

Compositions, thermoset compositions, and methods of forming the same, including an epoxy resin, a curing agent, and a silicone-acrylate core/shell rubber are disclosed.

### FIELD OF THE INVENTION

Embodiments disclosed herein relate to epoxy compositions. More specifically, embodiments disclosed herein relate to epoxy compositions useful in electrical laminates. More specifically, embodiments disclosed herein relate to low dielectric constant epoxy compositions formed from epoxy resins and core/shell toughening agents, such as a silicone-acrylate core/shell rubber.

### BACKGROUND

Thermosettable compositions useful in high-performance electrical applications, such as high-temperature circuit boards, must meet a set of demanding property requirements. For example, such materials optimally have good high-temperature properties such as high glass transition temperatures (e.g., above 200° C.) and low water absorption at elevated temperature (e.g., less than 4% water adsorption). Such materials must also exhibit stable solubility in organic solvents, such as acetone, as the preparation of electrical laminates conventionally involves impregnation of a porous glass web with a solution of the thermosettable resin. For ease of processing in preparing prepregs for composite parts, the uncured material will ideally have a low melting temperature (e.g., below 120° C.) and a wide temperature range of processable viscosity (a wide “processing window”).

Epoxy resins are one of the most widely used engineering resins, and are well-known for their use in electrical laminates. Epoxy resins have been used as materials for electrical/electronics equipment, such as materials for electrical laminates because of their superiority in heat resistance, chemical resistance, insulation property, dimensional stability, adhesiveness and the like.

As the industry switches to lead-free solders, there is an increasing demand for resins for printed circuit boards with improved thermal properties (e.g., a higher glass transition temperature (T_{g}) and a higher 5% decomposition temperature (T_{d})). For epoxy resins, which are the most common resins used to make printed circuit boards, a common strategy is to use epoxy compositions that result in a high crosslink density to achieve the desired thermal properties. Unfortunately, such an approach may result in an undesired increase in the brittleness of the resulting material. This brittleness can cause a variety of problems during the manufacture and use of printed circuit boards. One particular problem occurs during drilling. Resin brittleness can lead to fracture at the fiber-resin interface, leading to drill holes with rough surfaces. This in turn makes it difficult to plate with copper to form conductive vias, ultimately leading to non-functioning boards that must be re-worked or discarded.

A second trend is that the speed of electronic devices is increasing. In order to reduce signal loss and “crosstalk” between adjacent circuits, printed circuit boards with improved dielectric properties (e.g., a lower dielectric constant (Dₖ) and dissipation factor (D_{f})) are needed.

Accordingly, there exists a continuing need for compositions, having desirable toughness, dielectric properties, and thermal properties, that are useful in electrical laminates.

### SUMMARY OF INVENTION

In an embodiment of the invention, there is disclosed a composition comprising, consisting of, or consisting essentially of: an epoxy resin; a curing agent; and a silicone-acrylate core/shell rubber.

In another embodiment of the invention, there is disclosed a process comprising, consisting of, or consisting essentially of: dispersing a silicone-acrylate core/shell rubber in a solvent; admixing the dispersed silicone-acrylate core/shell rubber with an epoxy resin and one or more of a hardener, a catalyst, and additional solvent to form a curable composition.

### DETAILED DESCRIPTION

Embodiments disclosed herein relate to epoxy compositions. More specifically, embodiments disclosed herein relate to epoxy compositions useful in electrical laminates. More specifically, embodiments disclosed herein relate to low dielectric constant epoxy compositions formed from epoxy resins and core/shell toughening agents, such as a silicone-acrylate core/shell rubber.

Compositions disclosed herein may include at least one epoxy resin, at least one hardener or curing agent, and a silicone-acrylate core/shell rubber toughening agent. Such compositions are useful in electrical laminates, for example, due to the resulting thermoset resin having desirable electrical properties and physical properties, including impact resistance.

In some embodiments, curable compositions may be formed by dispersing a silicone-acrylate core/shell rubber toughening agent in a liquid epoxy resin. In other embodiments, curable compositions may be formed by dispersing a silicone-acrylate core/shell rubber toughening agent in a solvent, and then admixing the dispersion with an epoxy resin and one or more of a hardener, a catalyst, and additional solvent, to form a curable composition.

Thermoset compositions may be formed as a reaction product of the above-described curable compositions including at least one epoxy resin, at least one hardener, and a silicone-acrylate core/shell rubber. Such thermoset compositions are useful in electrical laminates, among other applications.

As described above, embodiments disclosed herein include various components, including epoxy resins, silicone-acrylate core/shell rubbers, and hardeners. Embodiments of compositions described herein may also include catalysts and various additives. Examples of each of these components are described in more detail below.

### Epoxy Resins

The epoxy resins used in embodiments disclosed herein may vary and include conventional and commercially available epoxy resins, which may be used alone or in combinations of two or more, including, for example, novolac resins, isocyanate modified epoxy resins, and carboxylate adducts, among others. In choosing epoxy resins for compositions disclosed herein, consideration should not only be given to properties of the final product, but also to viscosity and other properties that may influence the processing of the resin composition.

The epoxy resin component may be any type of epoxy resin useful in molding compositions, including any material containing one or more reactive oxirane groups, referred to herein as “epoxy groups” or “epoxy functionality.” Epoxy resins useful in embodiments disclosed herein may include mono-functional epoxy resins, multi- or poly-functional epoxy resins, and combinations thereof. Monomeric and polymeric epoxy resins may be aliphatic, cycloaliphatic, aromatic, or heterocyclic epoxy resins. The polymeric epoxies include linear polymers having terminal epoxy groups (a diglycidyl ether of a polyoxyalkylene glycol, for example), polymer skeletal oxirane units (polybutadiene polyepoxide, for example) and polymers having pendant epoxy groups (such as a glycidyl methacrylate polymer or copolymer, for example). The epoxies may be pure compounds, but are generally mixtures or compounds containing one, two or more epoxy groups per molecule. In some embodiments, epoxy resins may also include reactive —OH groups, which may react at higher temperatures with anhydrides, organic acids, amino resins, phenolic resins, or with epoxy groups (when catalyzed) to result in additional crosslinking.

In general, the epoxy resins may be glycidyl ethers, cycloaliphatic resins, epoxidized oils, and so forth. Illustrative polyepoxide compounds useful in embodiments disclosed herein are described in the 2^{nd} chapter of “Epoxy Resins” by Clayton A. May, published in 1988 by Marcel Dekker, Inc., New York, and U.S. Pat. No. 4,066,628. The glycidyl ethers are frequently the reaction product of epichlorohydrin and a phenol or polyphenolic compound such as bisphenol A (commercially available as D.E.R.™ 383 or D.E.R.™ 330 from The Dow Chemical Company, Midland, Mich.); pyrocatechol, resorcinol, hydroquinone, 4,4′-dihydroxydiphenyl methane (or bisphenol F), 4,4′-dihydroxy-3,3′-dimethyldiphenyl methane, 4,4′-dihydroxydiphenyl dimethyl methane (or bisphenol A), 4,4′-dihydroxydiphenyl methyl methane, 4,4′-dihydroxydiphenyl cyclohexane, 4,4′-dihydroxy-3,3′-dimethyldiphenyl propane, 4,4′-dihydroxydiphenyl sulfone, and tris(4-hydroxyphenyl)methane; chlorinated or brominated products of the above-mentioned diphenols, such as tetrabromobisphenol A. As is well-known in the art, such materials typically contain small amounts of oligomers derived from condensation of the phenolic starting material with the glycidyl ether product. ‘Advanced’ resins are prepared by reacting a polyepoxide with a polyphenol. Such oligomers are useful in the formulation to achieve useful rheology and cure characteristics. Specific examples include the condensation products of bisphenol A diglycidyl ether with bisphenol A, tetrabromobisphenol A or the condensation products of the diglycidyl ether of tetrabromobisphenol A with bisphenol A or tetrabromobisphenol A. In addition, aromatic isocyanates such as methylene diisocyanate or toluene diisocyanate may be added during these advancement reactions to give oligomers that contain oxazolidinone heterocycles in the backbone of the chains. Commercial examples are D.E.R.™ 592 and D.E.R.™ 593, each available from The Dow Chemical Company, Midland Mich. It is common to add the glycidyl ethers of novolacs, which are polyphenols derived from condensation of formaldehyde or other aldehyde with a phenol. Specific examples include the novolacs of phenol, cresol, dimethylphenols, p-hydroxybiphenyl, naphthol, and bromophenols.

Other epoxy resins are derived from epoxidation of olefins, typically with peracids or hydrogen peroxide. The olefins may be contained within a linear or cyclic chain.

In some embodiments, the epoxy resin may include glycidyl ether type;

glycidyl-ester type; alicyclic type; heterocyclic type, and halogenated epoxy resins, etc. Non-limiting examples of suitable epoxy resins may include cresol novolac epoxy resin, phenolic novolac epoxy resin, biphenyl epoxy resin, hydroquinone epoxy resin, stilbene epoxy resin, and mixtures and combinations thereof.

Suitable polyepoxy compounds may include resorcinol diglycidyl ether (1,3-bis-(2,3-epoxypropoxy)benzene), diglycidyl ether of bisphenol A (2,2-bis(p-(2,3-epoxypropoxy)phenyl)propane), triglycidyl p-aminophenol (4-(2,3-epoxypropoxy)-N,N-bis(2,3-epoxypropyl)aniline), diglycidyl ether of bromobisphenol A (2,2-bis(4-(2,3-epoxypropoxy)3-bromo-phenyl)propane), diglycidyl ether of bisphenol F (2,2-bis(p-(2,3-epoxypropoxy)phenyl)methane), triglycidyl ether of meta- and/or para-aminophenol (3-(2,3-epoxypropoxy)N,N-bis(2,3-epoxypropyl)aniline), and tetraglycidyl methylene dianiline (N,N,N′,N′-tetra(2,3-epoxypropyl) 4,4′-diaminodiphenyl methane), and mixtures of two or more polyepoxy compounds. A more exhaustive list of useful epoxy resins found may be found in Lee, H. and Neville, K., Handbook of Epoxy Resins, McGraw-Hill Book Company, 1982 reissue.

Other suitable epoxy resins include polyepoxy compounds based on aromatic amines and epichlorohydrin, such as N,N′-diglycidyl-aniline; N,N′-dimethyl-N,N′-diglycidyl-4,4′-diaminodiphenyl methane; N,N,N′,N′-tetraglycidyl-4,4′-diaminodiphenyl methane; N-diglycidyl-4-aminophenyl glycidyl ether; and N,N,N′,N′-tetraglycidyl-1,3-propylene bis-4-aminobenzoate. Epoxy resins may also include glycidyl derivatives of one or more of: aromatic diamines, aniline and substituted derivatives, aminophenols, polyhydric phenols, polyhydric alcohols, polycarboxylic acids.

Useful epoxy resins include, for example, polyglycidyl ethers of polyhydric polyols, such as ethylene glycol, triethylene glycol, 1,2-propylene glycol, 1,5-pentanediol, 1,2,6-hexanetriol, glycerol, and 2,2-bis(4-hydroxy cyclohexyl)propane; polyglycidyl ethers of aliphatic and aromatic polycarboxylic acids, such as, for example, oxalic acid, succinic acid, glutaric acid, terephthalic acid, 2,6-napthalene dicarboxylic acid, and dimerized linoleic acid; polyglycidyl ethers of polyphenols, such as, for example, bis-phenol A, bis-phenol F, 1,1-bis(4-hydroxyphenyl)ethane, 1,1-bis(4-hydroxyphenyl)isobutane, and 1,5-dihydroxy naphthalene; modified epoxy resins with acrylate or urethane moieties; glycidylamine epoxy resins; and novolac resins.

The epoxy compounds may be cycloaliphatic or alicyclic epoxides. Examples of cycloaliphatic epoxides include diepoxides of cycloaliphatic esters of dicarboxylic acids such as bis(3,4-epoxycyclohexylmethyl)oxalate, bis(3,4-epoxycyclohexylmethyl)adipate, bis(3,4-epoxy-6-methylcyclohexylmethyl)adipate, bis(3,4-epoxycyclohexylmethyl)pimelate; vinylcyclohexene diepoxide; limonene diepoxide; dicyclopentadiene diepoxide; and the like. Other suitable diepoxides of cycloaliphatic esters of dicarboxylic acids are described, for example, in U.S. Pat. No. 2,750,395.

Other cycloaliphatic epoxides include 3,4-epoxycyclohexylmethyl-3,4-epoxycyclohexane carboxylates such as 3,4-epoxycyclohexylmethyl-3,4-epoxycyclohexane carboxylate; 3,4-epoxy-1-methylcyclohexyl-methyl-3,4-epoxy-1-methylcyclohexane carboxylate; 6-methyl-3,4-epoxycyclohexylmethylmethyl-6-methyl-3,4-epoxycyclohexane carboxylate; 3,4-epoxy-2-methylcyclohexylmethyl-3,4-epoxy-2-methylcyclohexane carboxylate; 3,4-epoxy-3-methylcyclohexyl-methyl-3,4-epoxy-3-methylcyclohexane carboxylate; 3,4-epoxy-5-methylcyclohexyl-methyl-3,4-epoxy-5-methylcyclohexane carboxylate and the like. Other suitable 3,4-epoxycyclohexylmethyl-3,4-epoxycyclohexane carboxylates are described, for example, in U.S. Pat. No. 2,890,194.

Further epoxy-containing materials which are particularly useful include those based on glycidyl ether monomers. Examples are di- or polyglycidyl ethers of polyhydric phenols obtained by reacting a polyhydric phenol with an excess of chlorohydrin such as epichlorohydrin. Such polyhydric phenols include resorcinol, bis(4-hydroxyphenyl)methane (known as bisphenol F), 2,2-bis(4-hydroxyphenyl)propane (known as bisphenol A), 2,2-bis(4′-hydroxy-3′,5′-dibromophenyl)propane, 1,1,2,2-tetrakis(4′-hydroxy-phenyl)ethane or condensates of phenols with formaldehyde that are obtained under acid conditions such as phenol novolacs and cresol novolacs. Examples of this type of epoxy resin are described in U.S. Pat. No. 3,018,262. Other examples include di- or polyglycidyl ethers of polyhydric alcohols such as 1,4-butanediol, or polyalkylene glycols such as polypropylene glycol and di- or polyglycidyl ethers of cycloaliphatic polyols such as 2,2-bis(4-hydroxycyclohexyl)propane. Other examples are monofunctional resins such as cresyl glycidyl ether or butyl glycidyl ether.

Another class of epoxy compounds are polyglycidyl esters and poly(beta-methylglycidyl) esters of polyvalent carboxylic acids such as phthalic acid, terephthalic acid, tetrahydrophthalic acid or hexahydrophthalic acid. A further class of epoxy compounds are N-glycidyl derivatives of amines, amides and heterocyclic nitrogen bases such as N,N-diglycidyl aniline, N,N-diglycidyl toluidine, N,N,N′,N′-tetraglycidyl bis(4-aminophenyl)methane, triglycidyl isocyanurate, N,N′-diglycidyl ethyl urea, N,N′-diglycidyl-5,5-dimethylhydantoin, and N,N′-diglycidyl-5-isopropylhydantoin.

Still other epoxy-containing materials are copolymers of acrylic acid esters of glycidol such as glycidyl acrylate and glycidyl methacrylate with one or more copolymerizable vinyl compounds. Examples of such copolymers are 1:1 styrene-glycidyl methacrylate, 1:1 methyl methacrylate glycidyl acrylate and a 62.5:24:13.5 methyl methacrylate-ethyl acrylate-glycidyl methacrylate.

Epoxy compounds that are readily available include octadecylene oxide; glycidylmethacrylate; diglycidyl ether of bisphenol A; D.E.R.™ 331 (bisphenol A liquid epoxy resin) and D.E.R.™ 332 (diglycidyl ether of bisphenol A) available from The Dow Chemical Company, Midland, Mich.; vinylcyclohexene dioxide; 3,4-epoxycyclohexylmethyl-3,4-epoxycyclohexane carboxylate; 3,4-epoxy-6-methylcyclohexyl-methyl-3,4-epoxy-6-methylcyclohexane carboxylate; bis(3,4-epoxy-6-methylcyclohexylmethyl) adipate; bis(2,3-epoxycyclopentyl) ether; aliphatic epoxy modified with polypropylene glycol; dipentene dioxide; epoxidized polybutadiene; silicone resin containing epoxy functionality; flame retardant epoxy resins (such as a brominated epoxy resin available under the tradename D.E.R.™ 592 or a brominated bisphenol type epoxy resin available under the tradename D.E.R.™ 560, available from The Dow Chemical Company, Midland, Mich.); 1,4-butanediol diglycidyl ether of phenol formaldehyde novolac (such as those available under the tradenames D.E.N.™ 431 and D.E.N.™ 438 available from The Dow Chemical Company, Midland, Mich.); and resorcinol diglycidyl ether. Although not specifically mentioned, other epoxy resins under the trade name designations D.E.R.™ and D.E.N.™ available from The Dow Chemical Company may also be used.

Epoxy resins may also include isocyanate modified epoxy resins. Polyepoxide polymers or copolymers with isocyanate or polyisocyanate functionality may include epoxy-polyurethane copolymers. These materials may be formed by the use of a polyepoxide prepolymer having one or more oxirane rings to give a 1,2-epoxy functionality and also having open oxirane rings, which are useful as the hydroxyl groups for the dihydroxyl-containing compounds for reaction with diisocyanate or polyisocyanates. The isocyanate moiety opens the oxirane ring and the reaction continues as an isocyanate reaction with a primary or secondary hydroxyl group. There is sufficient epoxide functionality on the polyepoxide resin to enable the production of an epoxy polyurethane copolymer still having effective oxirane rings. Linear polymers may be produced through reactions of diepoxides and diisocyanates. The di- or polyisocyanates may be aromatic or aliphatic in some embodiments.

Mixtures of any of the above-listed epoxy resins may, of course, also be used.

### Silicone-Acrylate Core/Shell Rubber Toughening Agents

Silicone-acrylate core/shell rubber toughening agents may be used to prevent the composites disclosed herein from becoming brittle when the epoxy resin cures. In some embodiments, silicone-acrylate core/shell rubber toughening agents may be a rubber compound including a silicone rubber core and an acrylate polymer shell.

While not wishing to be bound by theory, it is believed that the silicone-acrylate core/shell rubber toughening agents used in embodiments disclosed herein functions by forming a secondary phase within the epoxy polymer matrix. This secondary phase is rubbery and hence is capable of crack growth arrestment, providing improved toughness.

Silicone-acrylate core/shell rubbers useful in embodiments disclosed herein may contain particulate, highly cross-linked silicone rubber particles of an average diameter (d₅₀) of from 0.1 to 3 microns, in particular from 0.1 to 1 micron, and gel contents greater than 60 wt-%, in particular greater than 80 wt-% (where particle size is as measured by light scattering techniques, and gel content is measured by solvent dissolution techniques). The acrylate rubber which is grafted on to the silicone rubber particles is present in the silicone/acrylate core/shell rubbers preferably in quantities of 50 wt-% or less, in particular in quantities of from 30 to 5 wt-% and may have gel contents >70 wt-%, in particular >85 wt-%. The acrylate rubber moiety of the silicone-acrylate core/shell rubbers is polymerized on to the silicone rubber particles; the following can thus form: graft polymers in the sense of covalent compounds of silicone rubber and acrylate rubber, cross-linked acrylate rubber moieties which encase the silicone rubber particles in a manner more or less mechanical, and optionally small quantities of soluble acrylate rubbers. As used herein, silicone-acrylate core/shell rubbers designate the reaction products which are obtained by polymerization of acrylate in the presence of silicone rubber particles, irrespective of the actual extent of grafting. The silicone rubber backbone, in some embodiments, may also be a cross-linked silicone rubber.

In some embodiments, the silicone rubbers contain groups which can be rendered capable of radical addition or transfer reaction. Such groups may include vinyl, allyl, chloroalkyl and mercapto groups, in quantities of from 2 to 10 mole %, calculated on the radicals R.

The acrylate rubber polymer b) grafted on to the silicone rubber core a) represents a partially to highly cross-linked acrylate rubber and is a polymer of from 100 to 60 weight percent alkyl acrylate, from 60 to 0 weight percent of other monomers which are copolymerizable with alkyl acrylate, and, if necessary, from 0.1 to 10 weight percent, calculated on the sum of alkyl acrylate and other monomers, of a cross-linking monomer having at least two vinyl and/or allyl groups in the molecule.

Alkyl acrylates may include C₄ to C₁₄ alkyl acrylates, such as, for example, methyl, ethyl, butyl, octyl and 2-ethylhexyl acrylate, chloroethyl acrylate, benzyl acrylate, phenethyl acrylate, such as C₁ to C₆ alkyl esters, including butyl acrylate. Monomers that are copolymerizable with the alkyl acrylates may include styrene, alpha-methylstyrene, halostyrene, methoxystyrene, acrylonitrile, methacrylonitrile, C₁ to C₈ alkyl methacrylates which may be substituted in the alkyl radical optionally by functional groups such as hydroxyl, epoxy or amine groups, for example methyl methacrylate, cyclohexyl methacrylate, glycidyl methacrylate, hydroxyethyl methacrylate, hydroxypropyl methacrylate, (meth)acrylic acid, maleic acid (ester), fumaric acid, itaconic acid, (meth)acrylamides, vinyl acetate, vinyl propionate or N-methylol compounds of (meth)acrylamides.

Cross-linking monomers may include esters of unsaturated carboxylic acids having a polyol (preferably from 2 to 20 carbon atoms in the ester group), such as ethylene glycol dimethacrylate, esters of a polyfunctional carboxylic acid having an unsaturated alcohol (preferably from 8 to 30 carbon atoms in the ester radical), such as triallyl cyanurate, triallyl isocyanurate; divinyl compounds such as divinylbenzene; esters of unsaturated carboxylic acids having unsaturated alcohols (preferably from 6 to 12 carbon atoms in the ester radical) such as allyl methacrylate; phosphoric acid esters, for example triallyl phosphate and 1,3,5-triacrylolylhexahydro-s-triazine.

The silicone-acrylate core/shell rubbers may be prepared, for example, in aqueous emulsion in the following manner: in a first stage, the silicone rubber, that is to say the core a), is first prepared by emulsion polymerizing a silicone oligomer.

In a second stage the monomers (alkyl acrylate, optionally cross-linking monomers and optionally further monomers) which form the acrylate rubber b) are then graft polymerized in the presence of the silicone rubber emulsion of the first stage. Formation of new particles should be as far as possible suppressed during this graft polymerization. An emulsion stabilizer is present in the quantity necessary for covering the surface of the particles. Graft polymerization is preferably accomplished within the temperature range 30° C. to 90° C., and is initiated by known radical initiators, for example, azo-initiators, peroxides, peresters, persulphates, perphosphates or by redox initiator systems. Following the graft polymerization of b) on to the silicone rubber particles a), stable aqueous emulsions of the silicone rubber/acrylate rubber particles arise, normally with polymer solids contents within the range 20 to 50 wt-%.

The amount of silicone-acrylate core/shell rubber toughening agents used in the curable compositions described herein may depend on a variety of factors including the equivalent weight of the polymers, as well as the desired properties of the products made from the composition. In general, the amount of silicone-acrylate core/shell rubber may be used in an amount ranging from 0.1 weight percent to 30 weight percent in some embodiments, from 0.5 weight percent to 10 weight percent in other embodiments, and from 1 weight percent to 5 weight percent in yet other embodiments, based on the total weight of the curable composition.

### Solvents

Another component, which may be added to the compositions disclosed herein, is a solvent or a blend of solvents. The solvent used in the epoxy resin composition may be miscible with the other components in the resin composition. The solvent used may be selected from those typically used in making electrical laminates. Examples of suitable solvents employed in the present invention include, for example, ketones, ethers, acetates, aromatic hydrocarbons, cyclohexanone, dimethylformamide, glycol ethers, and combinations thereof.

Solvents for the catalyst and the inhibitor may include polar solvents. Lower alcohols having from 1 to 20 carbon atoms, such as, for example, methanol, provide good solubility and volatility for removal from the resin matrix when prepregs are formed. Other useful solvents may include, for example, acetone, methyl ethyl ketone, DOWANOL PMA, N-methyl-2-pyrrolidone, dimethyl sulfoxide, dimethyl formamide, tetrahydrofuran, 1, 2-propane diol, ethylene glycol and glycerine.

The total amount of solvent used in the curable epoxy resin composition generally may range from about 1 to about 65 weight percent in some embodiments. In other embodiments, the total amount of solvent may range from 2 to 60 weight percent; from 3 to 50 weight percent in other embodiments; and from 5 to 40 weight percent in yet other embodiments.

Mixtures of one or more of the above described solvents may also be used.

### Catalysts

Optionally, catalysts may be added to the curable compositions described above. Catalysts may include imidazole compounds including compounds having one imidazole ring per molecule, such as imidazole, 2-methylimidazole, 2-ethyl-4-methylimidazole, 2-undecylimidazole, 2-heptadecylimidazole, 2-phenylimidazole, 2-phenyl-4-methylimidazole, 1-benzyl-2-methylimidazole, 2-ethylimidazole, 2-isopropylimidazole, 2-phenyl-4-benzylimidazole, 1-cyanoethyl-2-methylimidazole, 1-cyanoethyl-2-ethyl-4-methylimidazole, 1-cyanoethyl-2-undecylimidazole, 1-cyanoethyl-2-isopropylimidazole, 1-cyanoethyl-2-phenylimidazole, 2,4-diamino-6-[2′-methylimidazolyl-(1)′]-ethyl-s-triazine, 2,4-diamino-6-[2′-ethyl-4-methylimidazolyl-(1)′]-ethyl-s-triazine, 2,4-diamino-6-[2′-undecylimidazolyl-(1)′]-ethyl-s-triazine, 2-methyl-imidazolium-isocyanuric acid adduct, 2-phenylimidazolium-isocyanuric acid adduct, 1-aminoethyl-2-methylimidazole, 2-phenyl-4,5-dihydroxymethylimidazole, 2-phenyl-4-methyl-5-hydroxymethylimidazole, 2-phenyl-4-benzyl-5-hydroxymethylimidazole and the like; and compounds containing 2 or more imidazole rings per molecule which are obtained by dehydrating above-named hydroxymethyl-containing imidazole compounds such as 2-phenyl-4,5-dihydroxymethylimidazole, 2-phenyl-4-methyl-5-hydroxymethylimidazole and 2-phenyl-4-benzyl-5-hydroxy-methylimidazole; and condensing them with formaldehyde, e.g., 4,4′-methylene-bis-(2-ethyl-5-methylimidazole), and the like.

In other embodiments, suitable catalysts may include amine catalysts such as N-alkylmorpholines, N-alkylalkanolamines, N,N-dialkylcyclohexylamines, and alkylamines where the alkyl groups are methyl, ethyl, propyl, butyl and isomeric forms thereof, and heterocyclic amines.

Non-amine catalysts may also be used. Organometallic compounds of bismuth, lead, tin, titanium, iron, antimony, uranium, cadmium, cobalt, thorium, aluminum, mercury, zinc, nickel, cerium, molybdenum, vanadium, copper, manganese, and zirconium, may be used. Illustrative examples include bismuth nitrate, lead 2-ethylhexoate, lead benzoate, ferric chloride, antimony trichloride, stannous acetate, stannous octoate, and stannous 2-ethylhexoate. Other catalysts that may be used are disclosed in, for example, PCT Publication No. WO 00/15690, which is incorporated by reference in its entirety.

In some embodiments, suitable catalysts may include nucleophilic amines and phosphines, especially nitrogen heterocycles such as alkylated imidazoles: 2-phenyl imidazole, 2-methyl imidazole, 1-methyl imidazole, 2-methyl-4-ethyl imidazole; other heterocycles such as diazabicycloundecene (DBU), diazabicyclooctene, hexamethylenetetramine, morpholine, piperidine; trialkylamines such as triethylamine, trimethylamine, benzyldimethyl amine; phosphines such as triphenylphosphine, tritolylphosphine, triethylphosphine; quaternary salts such as triethylammonium chloride, tetraethylammonium chloride, tetraethylammonium acetate, triphenylphosphonium acetate, and triphenylphosphonium iodide.

Mixtures of one or more of the above described catalysts may also be used.

### Epoxy Hardeners/Curing Agents

A hardener or curing agent may be provided for promoting crosslinking of the curable composition to form a thermoset composition. The hardeners and curing agents may be used individually or as a mixture of two or more. In some embodiments, hardeners may include dicyandiamide (dicy) or phenolic curing agents such as novolacs, resoles, bisphenols. Other hardeners may include advanced (oligomeric) epoxy resins, some of which are disclosed above. Examples of advanced epoxy resin hardeners may include, for example, epoxy resins prepared from bisphenol A diglycidyl ether (or the diglycidyl ether of tetrabromobisphenol A) and an excess of bisphenol or (tetrabromobisphenol). Anhydrides such as poly(styrene-co-maleic anhydride) may also be used.

Curing agents may also include primary and secondary polyamines and adducts thereof, anhydrides, and polyamides. For example, polyfunctional amines may include aliphatic amine compounds such as diethylene triamine (D.E.H.™ 20, available from The Dow Chemical Company, Midland, Mich.), triethylene tetramine (D.E.H.™ 24, available from The Dow Chemical Company, Midland, Mich.), tetraethylene pentamine (D.E.H.™ 26, available from The Dow Chemical Company, Midland, Mich.), as well as adducts of the above amines with epoxy resins, diluents, or other amine-reactive compounds. Aromatic amines, such as metaphenylene diamine and diamine diphenyl sulfone, aliphatic polyamines, such as amino ethyl piperazine and polyethylene polyamine, and aromatic polyamines, such as metaphenylene diamine, diamino diphenyl sulfone, and diethyltoluene diamine, may also be used.

Anhydride curing agents may include, for example, nadic methyl anhydride, hexahydrophthalic anhydride, trimellitic anhydride, dodecenyl succinic anhydride, phthalic anhydride, methyl hexahydrophthalic anhydride, tetrahydrophthalic anhydride, and methyl tetrahydrophthalic anhydride, among others.

The hardener or curing agent may include a phenol-derived or substituted phenol-derived novolac or an anhydride. Non-limiting examples of suitable hardeners include phenol novolac hardener, cresol novolac hardener, dicyclopentadiene bisphenol hardener, limonene type hardener, anhydrides, and mixtures thereof.

In some embodiments, the phenol novolac hardener may contain a biphenyl or naphthyl moiety. The phenolic hydroxy groups may be attached to the biphenyl or naphthyl moiety of the compound. One method of preparing a hardener containing a biphenyl moiety may be prepared by reacting phenol with bismethoxy-methylene biphenyl.

In other embodiments, curing agents may include dicyandiamide, boron trifluoride monoethylamine, and diaminocyclohexane. Curing agents may also include imidazoles, their salts, and adducts. These epoxy curing agents are typically solid at room temperature. Examples of suitable imidazole curing agents include but are not limited to imidazole, 2-methylimidazole, 2-propylimidazole, 4-(hydroxymethyl)imidazole, 2-phenylimidazole, 2-benzyl-4-methylimizdazole, and benzimidazole. Other curing agents include phenolic, benzoxazine, aromatic amines, amido amines, aliphatic amines, anhydrides, and phenols.

In some embodiments, the curing agents may be polyamides or an amino compound having a molecular weight up to 500 per amino group, such as an aromatic amine or a guanidine derivative. Examples of amino curing agents include 4-chlorophenyl-N,N-dimethyl-urea and 3,4-dichlorophenyl-N,N-dimethyl-urea.

Other examples of curing agents useful in embodiments disclosed herein include: 3,3′- and 4,4′-diaminodiphenylsulfone; methylenedianiline; bis(4-amino-3,5-dimethyl-phenyl)-1,4-diisopropylbenzene available as EPON 1062 from Shell Chemical Co.; and bis(4-aminophenyl)-1,4-diisopropylbenzene available as EPON 1061 from Hexion Chemical Co.

Thiol curing agents for epoxy compounds may also be used. As used herein, “thiol” also includes polythiol or polymercaptan curing agents. Illustrative thiols include aliphatic thiols such as methanedithiol, propanedithiol, cyclohexanedithiol, 2-mercaptoethyl-2,3-dimercapto-succinate, 2,3-dimercapto-1-propanol(2-mercaptoacetate), diethylene glycol bis(2-mercaptoacetate), 1,2-dimercaptopropyl methyl ether, bis(2-mercaptoethyl)ether, trimethylolpropane tris(thioglycolate), pentaerythritol tetra(mercaptopropionate), pentaerythritol tetra(thioglycolate), ethyleneglycol dithioglycolate, trimethylolpropane tris(beta-thiopropionate), tris-mercaptan derivative of tri-glycidyl ether of propoxylated alkane, and dipentaerythritol poly(beta-thiopropionate); halogen-substituted derivatives of the aliphatic thiols; aromatic thiols such as di-, tris- or tetra-mercaptobenzene, bis-, tris- or tetra-(mercaptoalkyl)benzene, dimercaptobiphenyl, toluenedithiol and naphthalenedithiol; halogen-substituted derivatives of the aromatic thiols; heterocyclic ring-containing thiols such as amino-4,6-dithiol-sym-triazine, alkoxy-4,6-dithiol-sym-triazine, aryloxy-4,6-dithiol-sym-triazine and 1,3,5-tris(3-mercaptopropyl) isocyanurate; halogen-substituted derivatives of the heterocyclic ring-containing thiols; thiol compounds having at least two mercapto groups and containing sulfur atoms in addition to the mercapto groups such as bis-, tris- or tetra(mercaptoalkylthio)benzene, bis-, tris- or tetra(mercaptoalkylthio)alkane, bis(mercaptoalkyl) disulfide, hydroxyalkylsulfidebis(mercaptopropionate), hydroxyalkylsulfidebis(mercaptoacetate), mercaptoethyl ether bis(mercaptopropionate), 1,4-dithian-2,5-diolbis(mercaptoacetate), thiodiglycolic acid bis(mercaptoalkyl ester), thiodipropionic acid bis(2-mercaptoalkyl ester), 4,4-thiobutyric acid bis(2-mercaptoalkyl ester), 3,4-thiophenedithiol, bismuththiol and 2,5-dimercapto-1,3,4-thiadiazol.

The curing agent may also be a nucleophilic substance such as an amine, a tertiary phosphine, a quaternary ammonium salt with a nucleophilic anion, a quaternary phosphonium salt with a nucleophilic anion, an imidazole, a tertiary arsenium salt with a nucleophilic anion, and a tertiary sulfonium salt with a nucleophilic anion.

Aliphatic polyamines that are modified by adduction with epoxy resins, acrylonitrile, or methacrylates may also be utilized as curing agents. In addition, various Mannich bases can be used. Aromatic amines wherein the amine groups are directly attached to the aromatic ring may also be used.

Quaternary ammonium salts with a nucleophilic anion useful as a curing agent in embodiments disclosed herein may include tetraethyl ammonium chloride, tetrapropyl ammonium acetate, hexyl trimethyl ammonium bromide, benzyl trimethyl ammonium cyanide, cetyl triethyl ammonium azide, N,N-dimethylpyrrolidinium isocyanate, N-methylpyrridinium phenolate, N-methyl-o-chloropyridinium chloride, methyl viologen dichloride and the like.

The suitability of the curing agent for use herein may be determined by reference to manufacturer specifications or routine experimentation. Manufacturer specifications may be used to determine if the curing agent is an amorphous solid or a crystalline solid at the desired temperatures for mixing with the liquid or solid epoxy. Alternatively, the solid curing agent may be tested using differential scanning calorimetry (DSC) to determine the amorphous or crystalline nature of the solid curing agent and the suitability of the curing agent for mixing with the resin composition in either liquid or solid form.

Mixtures of one or more of the above described epoxy hardeners and curing agents may also be used.

### Flame Retardant Additives

As described above, the curable compositions described herein may be used in formulations that contain halogenated and non-halogenated flame retardants, including brominated and non-brominated flame retardants. Specific examples of brominated additives include tetrabromobisphenol A (TBBA) and materials derived therefrom: TBBA-diglycidyl ether, reaction products of bisphenol A or TBBA with TBBA-diglycidyl ether, and reaction products of bisphenol A diglycidyl ether with TBBA.

Non-brominated flame retardants include the various materials derived from DOP (9,10-dihydro-9-oxa-10-phosphaphenanthrene 10-oxide) such as DOP-hydroquinone (10-(2′,5′-dihydroxyphenyl)-9,10-dihydro-9-oxa-10-phosphaphenanthrene 10-oxide), condensation products of DOP with glycidyl ether derivatives of novolacs, and inorganic flame retardants such as aluminum trihydrate and aluminum phosphinite.

Mixtures of one or more of the above described flame retardant additives may also be used.

### Other Additives

Compositions disclosed herein may optionally include synergists, and conventional additives and fillers. Synergists may include, for example, magnesium hydroxide, zinc borate, and metallocenes), solvents (e.g., acetone, methyl ethyl ketone, and DOWANOL™ PMA). Additives and fillers may include, for example, silica, glass, talc, metal powders, titanium dioxide, wetting agents, pigments, coloring agents, mold release agents, coupling agents, ion scavengers, UV stabilizers, flexibilizing agents, and tackifying agents. Additives and fillers may also include fumed silica, aggregates such as glass beads, polytetrafluoroethylene, polyol resins, polyester resins, phenolic resins, graphite, molybdenum disulfide, abrasive pigments, viscosity reducing agents, boron nitride, mica, nucleating agents, and stabilizers, among others. Fillers may include functional or non-functional particulate fillers that may have an average particle size ranging from 5 nm to 100 microns and may include, for example, alumina trihydrate, aluminum oxide, aluminum hydroxide oxide, metal oxides, and nano tubes). Fillers and modifiers may be preheated to drive off moisture prior to addition to the epoxy resin composition. Additionally, these optional additives may have an effect on the properties of the composition, before and/or after curing, and should be taken into account when formulating the composition and the desired reaction product.

In other embodiments, compositions disclosed herein may include additional toughening agents. Toughening agents function by forming a secondary phase within the polymer matrix. This secondary phase is rubbery and hence is capable of crack growth arrestment, providing improved impact toughness. Toughening agents may include polysulfones, silicon-containing elastomeric polymers, polysiloxanes, and other rubber toughening agents known in the art.

In some embodiments, minor amounts of higher molecular weight, relatively non-volatile monoalcohols, polyols, and other epoxy- or isocyanato-reactive diluents may be used, if desired, to serve as plasticizers in the curable and thermoset compositions disclosed herein. For example, isocyanates, isocyanurates, cyanate esters, allyl containing molecules or other ethylenically unsaturated compounds, and acrylates may be used in some embodiments. Exemplary non-reactive thermoplastic resins include polyphenylsulfones, polysulfones, polyethersulfones, polyvinylidene fluoride, polyetherimide, polyphthalimide, polybenzimidazole, acrylics, phenoxy, and urethane. In other embodiments, compositions disclosed herein may also include adhesion promoters such as modified organosilanes (epoxidized, methacryl, amino), acetylacetonates, and sulfur containing molecules.

In yet other embodiments, compositions disclosed herein may include wetting and dispersing aids, for example, modified organosilanes, BYK 900 series and W 9010, and modified fluorocarbons. In still other embodiments, compositions disclosed herein may include air release additives, for example, BYK A530, BYK A525, BYK A555, and BYK A560. Embodiments disclosed herein may also include surface modifiers (e.g., slip and gloss additives) and mold release agents (e.g., waxes), and other functional additives or prereacted products to improve polymer properties.

Some embodiments may include other co-reactants that may be incorporated to obtain specific properties of the curable and electrical laminate compositions disclosed herein. Mixtures of co-reactants and/or one or more of the above described additives may also be used.

In other embodiments, thermosetting compositions disclosed herein may include fibrous reinforcement materials, such as continuous and/or chopped fibers. The fibrous reinforcement material may include glass fibers, carbon fibers, or organic fibers such as polyamide, polyimide, and polyester. The concentration of fibrous reinforcements used in embodiments of the thermosetting compositions may be between about 1 percent to about 95 percent by weight, based on the total weight of the composition; between about 5 percent and 90 percent by weight in other embodiments; between about 10 percent and 80 percent in other embodiments; between about 20 percent and 70 percent in other embodiments; and between 30 percent and 60 percent in yet other embodiments.

In other embodiments, compositions disclosed herein may include nanofillers. Nanofillers may include inorganic, organic, or metallic, and may be in the form of powders, whiskers, fibers, plates or films. The nanofillers may be generally any filler or combination of fillers having at least one dimension (length, width, or thickness) from about 0.1 to about 100 nanometers. For example, for powders, the at least one dimension may be characterized as the grain size; for whiskers and fibers, the at least one dimension is the diameter; and for plates and films, the at least one dimension is the thickness. Clays, for example, may be dispersed in an epoxy resin-based matrix, and the clays may be broken down into very thin constituent layers when dispersed in the epoxy resin under shear. Nanofillers may include clays, organo-clays, carbon nanotubes, nanowhiskers (such as SiC), SiO₂, elements, anions, or salts of one or more elements selected from the s, p, d, and f groups of the periodic table, metals, metal oxides, and ceramics.

The concentration of any of the above described additives, when used in the thermosetting compositions described herein, may be between about 1 percent and 95 percent, based on the total weight of the composition; between 2 percent and 90 percent in other embodiments; between 5 percent and 80 percent in other embodiments; between 10 percent and 60 percent in other embodiments, and between 15 percent and 50 percent in yet other embodiments.

### Compositions

Curable or hardenable compositions, or varnishes prepared therefrom disclosed herein may include at least one epoxy resin, at least one curing agent, and at least one silicone-acrylate core/shell rubber toughening agent. In some embodiments, curable compositions and/or varnishes disclosed herein may additionally include a catalyst. In other embodiments, curable compositions and/or varnishes disclosed herein may include a reinforcing agent. Curable compositions and/or varnishes may be formed, in some embodiments, by admixing the above components.

The desired amount of epoxy resin in the curable composition and/or varnish may depend on the expected end use. Additionally, as detailed above, reinforcing materials may be used at substantial volume fractions; thus, the desired amount of epoxy resin may also depend on whether or not a reinforcing material is used. In some embodiments, curable compositions and/or varnishes may include from about 30 to about 98 volume percent epoxy resin. In other embodiments, curable compositions and/or varnishes may include 65 to 95 volume percent epoxy resin; from 70 to 90 volume percent epoxy resin in other embodiments; from 30 to 65 volume percent epoxy resin in other embodiments; and from 40 to 60 volume percent epoxy resin in yet other embodiments.

Compositions may include from about 0.1 to about 30 volume percent of the silicone-acrylate core/shell rubber toughening agent in some embodiments.

In other embodiments, curable compositions may include from about 1 to about 25 volume percent silicone-acrylate core/shell rubber toughening agent; and from about 2 to about 20 volume percent silicone-acrylate core/shell rubber toughening agent in yet other embodiments.

The amount of reinforcing material in the composition may vary depending on the type and form of the reinforcing material and the expected end product. Curable compositions may include from about 20 to about 70 volume percent reinforcing materials in some embodiments. In other embodiments, curable compositions may include from about 30 to about 65 volume percent reinforcing materials; and from 40 to 60 volume percent reinforcing materials in yet other embodiments.

Compositions may include from about 0.1 to about 50 volume percent optional additives in some embodiments. In other embodiments, curable compositions may include from about 0.1 to about 5 volume percent optional additives; and from 0.5 to 2.5 volume percent optional additives in yet other embodiments.

The amount of catalyst used may vary from 0.1 to 20 parts per hundred parts epoxy resin, by weight, in some embodiments. In other embodiments, catalyst may be used in an amount ranging from 1 to 15 parts per hundred parts epoxy resin, by weight; and from 2 to 10 parts per hundred parts epoxy resin, by weight, in yet other embodiments. The specific amount of catalyst used for a given system should be determined experimentally to develop the optimum in properties desired.

Similarly the specific amount of curing agent used for a given system should be determined experimentally to develop the optimum in properties desired. Variables to consider in selecting a curing agent and an amount of curing agent may include, for example, the epoxy resin composition (if a blend), the desired properties of the cured composition (flexibility, electrical properties, etc.), desired cure rates, as well as the number of reactive groups per catalyst molecule, such as the number of active hydrogens in an amine. The amount of curing agent used may vary from 0.1 to 150 parts per hundred parts epoxy resin, by weight, in some embodiments. In other embodiments, the curing agent may be used in an amount ranging from 5 to 95 parts per hundred parts epoxy resin, by weight; and the curing agent may be used in an amount ranging from 10 to 90 parts per hundred parts epoxy resin, by weight, in yet other embodiments.

### Electrical Laminate Compositions/Varnish

The proportions of components may depend, in part, upon the properties desired in the electrical laminate composition or coating to be produced, the desired cure response of the composition, and the desired storage stability of the composition (desired shelf life). For example, in some embodiments, curable compositions may be formed by admixing the epoxidized cycloaliphatic olefin polymer, one or more epoxy resins, one or more hardeners, and other components as desired, where the relative amounts of the components may depend upon the desired properties of the electrical laminate composition.

In some embodiments, the epoxidized cycloaliphatic olefin polymer may be present in curable compositions disclosed herein in an amount range from 0.1 to 5 weight percent of the curable composition. In other embodiments, the epoxidized cycloaliphatic olefin polymer may be present in curable compositions disclosed herein in an amount range from 0.5 to 2.5 weight percent of the curable composition; and from about 1.0 to 2.0 weight percent of the curable composition in other embodiments.

In some embodiments, the epoxy resin may be present in an amount range from 0.1 to 99 weight percent of the curable composition. In other embodiments, the epoxy resin may range from 5 to 90 weight percent of the curable composition; from 10 to 80 weight percent in other embodiments; and from 10 to 50 weight percent in yet other embodiments.

The proportions of other components may also depend, in part, upon the properties desired in the electrical laminate composition or coating to be produced. For example, variables to consider in selecting curing agents and amounts of curing agents may include the epoxy composition (if a blend), the desired properties of the electrical laminate composition (T_{g}, T_{d}, flexibility, electrical properties (Dₖ, D_{f}), etc.), desired cure rates, and the number of reactive groups per catalyst molecule, such as the number of active hydrogens in an amine. In some embodiments, the amount of curing agent used may vary from 0.1 to 150 parts per hundred parts epoxy resin, by weight. In other embodiments, the curing agent may be used in an amount ranging from 5 to 95 parts per hundred parts epoxy resin, by weight; and the curing agent may be used in an amount ranging from 10 to 90 parts per hundred parts epoxy resin, by weight, in yet other embodiments. In yet other embodiments, the amount of curing agent may depend on components other than the epoxy resin.

In some embodiments, thermoset resins formed from the above described curable compositions may have a glass transition temperature, as measured using differential scanning calorimetry, of at least 140° C. In other embodiments, thermoset resins formed from the above described curable compositions may have a glass transition temperature, as measured using differential scanning calorimetry, of at least 145° C.; at least 150° C. in other embodiments; at least 175° C. in other embodiments; and at least 200° C. in yet other embodiments.

The curable compositions described above may be disposed on or impregnated in a substrate and cured.

### Substrates

The substrate or object is not subject to particular limitation. As such, substrates may include metals, such as stainless steel, iron, steel, copper, zinc, tin, aluminum, alumite and the like; alloys of such metals, and sheets which are plated with such metals and laminated sheets of such metals. Substrates may also include polymers, glass, and various fibers, such as, for example, carbon/graphite; boron; quartz; aluminum oxide; glass such as E glass, S glass, S-2 GLASS® or C glass; and silicon carbide or silicon carbide fibers containing titanium. Commercially available fibers may include: organic fibers, such as KEVLAR; aluminum oxide-containing fibers, such as NEXTEL fibers from 3M; silicon carbide fibers, such as NICALON from Nippon Carbon; and silicon carbide fibers containing titanium, such as TYRRANO from Ube. In some embodiments, the substrate may be coated with a compatibilizer to improve the adhesion of the electrical laminate composition to the substrate.

### Composites and Coated Structures

In some embodiments, composites may be formed by curing the electrical laminate compositions disclosed herein. In other embodiments, composites may be formed by applying a curable epoxy resin composition to a substrate or a reinforcing material, such as by impregnating or coating the substrate or reinforcing material, and curing the electrical laminate composition.

After the varnish has been produced, as described above, it may be disposed on, in, or between the above described substrates, before, during, or after cure of an electrical laminate composition.

For example, a composite may be formed by coating a substrate with a varnish. Coating may be performed by various procedures, including spray coating, curtain flow coating, coating with a roll coater or a gravure coater, brush coating, and dipping or immersion coating.

In various embodiments, the substrate may be monolayer or multi-layer. For example, the substrate may be a composite of two alloys, a multi-layered polymeric article, and a metal-coated polymer, among others, for example. In other various embodiments, one or more layers of the curable composition may be disposed on a substrate. Other multi-layer composites, formed by various combinations of substrate layers and electrical laminate composition layers are also envisaged herein.

In some embodiments, the heating of the varnish may be localized, such as to avoid overheating of a temperature-sensitive substrate, for example. In other embodiments, the heating may include heating the substrate and the curable composition.

Curing of the curable compositions and/or varnishes disclosed herein may require a temperature of at least about 30° C., up to about 250° C., for periods of minutes up to hours, depending on the epoxy resin, curing agent, and catalyst, if used. In other embodiments, curing may occur at a temperature of at least 100° C., for periods of minutes up to hours. Post-treatments may be used as well, such post-treatments ordinarily being at temperatures between about 100° C. and 250° C.

In some embodiments, curing may be staged to prevent undesirable temperature excursions due to reaction exotherms. Staging, for example, includes curing for a period of time at a temperature followed by curing for a period of time at a higher temperature. Staged curing may include two or more curing stages, and may commence at temperatures below about 180° C. in some embodiments, and below about 150° C. in other embodiments.

In some embodiments, curing temperatures may range from a lower limit of 30° C., 40° C., 50° C., 60° C., 70° C., 80° C., 90° C., 100° C., 110° C., 120° C., 130° C., 140° C., 150° C., 160° C., 170° C., or 180° C. to an upper limit of 250° C., 240° C., 230° C., 220° C., 210° C., 200° C., 190° C., 180° C., 170° C., 160° C., where the range may be from any lower limit to any upper limit.

The curable compositions disclosed herein may be useful in composites containing high strength filaments or fibers such as carbon (graphite), glass, boron, and the like. Composites may contain from about 30% to about 70%, in some embodiments, and from 40% to 70% in other embodiments, of these fibers based on the total volume of the composite.

Fiber reinforced composites, for example, may be formed by hot melt prepregging. The prepregging method is characterized by impregnating bands or fabrics of continuous fiber with a thermosetting composition as described herein in molten form to yield a prepreg, which is laid up and cured to provide a composite of fiber and epoxy resin.

Other processing techniques can be used to form electrical laminate composites containing the curable compositions disclosed herein. For example, filament winding, solvent prepregging, and pultrusion are typical processing techniques in which the curable composition may be used. Moreover, fibers in the form of bundles may be coated with the curable composition, laid up as by filament winding, and cured to form a composite.

Composites disclosed herein containing silicone-acrylate core/shell rubber toughening agents may have a higher fracture toughness, with comparable electrical and thermal properties, than composites formed without the silicone-acrylate core/shell rubber toughening agents. In some embodiments, thermoset compositions formed according to embodiments disclosed herein may have a glass transition temperature, T_{g}, as measured using differential scanning calorimetry of at least 165° C. and a fracture toughness, k_{1c}, as measured according to ASTM D-5045, of at least 1.0 mPa m^{0.5}. In other embodiments, the thermoset compositions may have a glass transition temperature, as measured using differential scanning calorimetry of at least 170° C.; 175° C. in yet other embodiments.

Thermoset compositions formed according to embodiments disclosed herein may have a 5% decomposition temperature, T_{d}, as measured using thermogravimetric analysis (TGA) of at least 365° C. In other embodiments, the thermoset compositions may have a T_{d}, as measured using TGA of at least 370° C.; 375° C. in yet other embodiments.

It has also been found that silicone-acrylate core/shell rubber toughening agents used in thermoset resins according to embodiments disclosed herein may result in improved flame retardancy resulting from a synergistic effect between silicone, contained in the toughening agent, and bromine, contained in an added flame retardant. Flammability ratings are obtained by testing under UL-94 which requires the exposure of a defined test sample of material to a defined flame for a specified period of time. Ratings of V-0, V-1, and V-2 are obtained according to a number of criteria, including flame time, afterglow time, and cotton-igniting drips. Thermoset resins according to embodiments disclosed herein may have UL-94 vertical burn ratings of V-0, indicating that burning stops within 10 seconds after two applications of ten seconds each of a flame to a test bar, with no flaming drips. In some embodiments, the average time elapsed for the burning to stop (flame extinguishing time) during a first burn may be less than 0.9 seconds; less than 0.7 seconds in other embodiments.

The curable compositions and composites described herein may be useful as adhesives, structural and electrical laminates, coatings, marine coatings, composites, powder coatings, adhesives, castings, structures for the aerospace industry, and as circuit boards and the like for the electronics industry.

In some embodiments, the curable compositions and resulting thermoset resins may be used in composites, coatings, adhesives, or sealants that may be disposed on, in, or between various substrates. In other embodiments, the curable compositions may be applied to a substrate to obtain an epoxy based prepreg. As used herein, the substrates include, for example, glass cloth, a glass fiber, glass paper, paper, and similar substrates of polyethylene and polypropylene. The obtained prepreg may be cut into a desired size. An electrical conductive layer may be formed on the laminate/prepreg with an electrical conductive material. As used herein, suitable electrical conductive materials include electrical conductive metals such as copper, gold, silver, platinum and aluminum. Such electrical laminates may be used, for example, as multi-layer printed circuit boards for electrical or electronics equipment.

### EXAMPLES

### Sample Testing

The following Samples and Comparative Sample are analyzed for the thermal and mechanical characterization (including differential scanning calorimetry (DSC), thermomechanical analysis (TMA), dynamic mechanical thermal analysis (DMTA), thermogravimetric analysis (TGA), and mechanical testing (fracture toughness and tensile properties)).

Differential scanning calorimetry (DSC) experiments are performed on a TA Instruments (New Castle, DE) Q-1000 calorimeter. Two scans from an equilibrated temperature of 35° C. to 275° C. at 10° C./min under nitrogen with an interim cool-down at 10° C./min are performed for each sample in an open aluminum pan. A third scan is performed at a heating rate of 20° C./min. Reported glass transition temperature (T_{g}) values were measured from the inflection point of the heat capacity curve on the second scan.

Thermomechanical analysis (TMA) experiments are performed on a TA Instruments Q-400 with a micro-expansion probe. Samples are dried in a desiccator overnight prior to analysis, and the temperature is ramped twice to 275° C. at 10° C./min. T_{g} and coefficients of thermal expansion (CTE's) are calculated from the second scan.

“T260” is the time required for a laminate to begin to delaminate when heated to 260° C. A similar indicator is “T288,” which measures the delamination time at 288° C. T260 and T288 are also determined by thermogravimetric analysis (TMA). The sample is heated to 260° C. and held at that temperature until such time as a measureable change in sample thickness, as a result of thermal decomposition, is detected. T288 is measured in the same way, except the sample is heated to 288° C.

Dynamic mechanical thermal analysis (DMTA) is performed on an ARES LS rheometer (Rheometric Scientific, Piscataway, N.J.) equipped with an environmental controlled oven chamber and rectangular plate fixtures. For 1.75 inch by 0.5 inch by 0.125 inch samples, a 0.1% strain is applied at 1 Hz while ramping to 250° C. at 3° C./min.

Thermogravimetric analyses (TGA) experiments are performed on a TA

Instruments Q-50. Dry samples are analyzed by a ramp from room temperature to 600° C. at 10° C./min using nitrogen as a purge gas. The degradation temperatures (T_{d}) are determined by the temperature at which 5 percent of the starting mass was lost.

Fracture toughness (k_{1c} and G_{1c}) testing of the samples is performed in accordance with ASTM D-5045. The samples are cut using a water-jet cutter to minimize cracking and residual stress. A minimum of five analyses are performed and averaged.

Tensile testing is performed on selected samples according to ASTM D638 with the exception of sample size. For these tests, the nominally ⅛-inch thick thermoset plaques were cut into 0.5 inch by 2.75 inch pieces with a ⅛-inch gauge width.

Water uptake is measured by molding the sample powders (the powders of the epoxy resin compositions) to form test pieces with a thickness of 3 mm and a diameter of 50 mm. After being post-cured at 175° C., the test pieces are put into a constant temperature humidity chamber, which was set at a temperature of 85° C. and a relative humidity of 85%, for 72 hours. A variation in weight is measured before and after the chamber to calculate the water uptake.

Copper peel strength is measured in accordance with IPC-TM-650-2.4.8.

Flammability characteristics of the samples are measured according to UL-94V, vertical burning test, where the test is performed on at least 5 sample specimens.

Blistering during solder dip exposure resulting from a pre-conditioning moisture pickup was measured according to IPC test method TM-650.

### Example 1

15 grams of silicone-acrylate core/shell rubber (METABLEN SX-006, available from Mitsubishi Rayon) is added to 85 grams of methyl ethyl ketone (MEK) and thoroughly mixed using a rotor device at 2000 rpm for 30 minutes. A stable white dispersion is obtained for use in a laminate composition having the formulation as shown in Table 1. D.E.N.™ 438EK85 is a solution of a phenol epoxy novolac resin in MEK having multi-epoxy functionality of about 3.6, and having an epoxide equivalent weight of about 180 gram per equivalent, available from The Dow Chemical Company, Midland, Mich. D.E.R.™ 560 is a brominated epoxy resin of the tetrabromobisphenol A epichlorohydrin type having an epoxide equivalent weight of about 450 grams per equivalent, also available from The Dow Chemical Company, Midland, Mich.. ReziCure™ 3026 is a phenolic novolac hardener (epoxy curative/co-reactant) available from SI Group.

TABLE 1
Example 1 Formulation

| Component | Amount (wt. %) |
|---|---|
| D.E.N. ™ 438EK85 | 44.31 |
| D.E.R. ™ 560 | 22.14 |
| ReziCure ™ 3026 | 33.55 |
| Dispersed METABLEN | 5 pph |

The components as shown in Table 1 are added to a glass vessel and mixed in a shaker, and further MEK is added until the viscosity of the formulation is B on the Gardner scale. The total solids are 66.3%. After the solution becomes homogeneous, 2-methyl imidazole (0.3 wt. %) is added and the solution is shaken for 10 minutes.

The varnish prepared as described above is used to prepare hand paints. The laminates are then pressed using these hand paint prepregs. Properties of the laminates formed in Example 1 are compared to a control sample (Comparative Example) in Table 1A. The Comparative Example, is the same formulation described in Table 1, without the dispersed METABLEN, with the formulation of the Comparative Example given in Table 1A.

TABLE 1A
Formulation of
Comparative Example

| Component | Amount (wt. %) |
|---|---|
| D.E.N. ™ 438EK85 | 44.31 |
| D.E.R. ™ 560 | 22.14 |
| ReziCure ™ 3026 | 33.55 |

### Example 2

A varnish is prepared in a similar manner to that described for Example 1 having the formulation as shown in Table 2. The toughening agent used for this example is METABLEN SX-005, a silicone-acrylate core/shell rubber available from Mitsubishi Rayon.

TABLE 2

| | | | Target Formulation | | | |
|---|---|---|---|---|---|---|
| | | | | Solids | | Actual Formulation |
| Components | EEW (g/equiv) | % solids | phr | Wt % | Sol. Wt | Actual Wt |
| D.E.N. ™ 438 EK-85 | 180 | 85 | | 42.20 | 1849.06 | 1849.10 |
| D.E.R ™. 560 | 450 | 70 | | 21.09 | 1122.14 | 1122.90 |
| ReziCure ™ 3026 | 104 | 50 | 50.48 | 31.95 | 2380.00 | 2380.40 |
| Metablen SX-005 | 0 | 15 | | 4.76 | 1182.40 | 1182.38 |
| Total | | | | 100.00 | 6533.60 | 6534.78 |
| % Bromine | | | 10.3% | | | |
| | | | | Solids= | 57.01% | |
| 2-MI (20% NV in Dow PM) | | 20 | 0.047 | 0.030 | 5.50 | 5.00 |

### Example 3

A varnish is prepared in a similar manner to that described for Example 1 having the formulation as shown in Table 3. METABLEN SX-006 is a silicone-acrylate core/shell rubber available from Mitsubishi Rayon. D.E.R.™ 592 is a brominated epoxy resin having an epoxide equivalent weight of about 360 grams per equivalent, available from The Dow Chemical Company, Midland, Mich.

TABLE 3

| | | | Target Formulation | | | Actual |
|---|---|---|---|---|---|---|
| | | | | Solids | | Formulation |
| Components | EEW (g/equiv) | % solids | phr | Wt % | Sol. Wt | Actual Wt |
| D.E.R. ™ 592 - A80 | 360 | 80 | | 0.00 | 0.00 | 0.00 |
| D.E.N. ™ 438 EK-85 | 180 | 85 | | 42.20 | 1849.06 | 1849.16 |
| D.E.R. ™ 560 | 450 | 70 | | 21.09 | 1122.14 | 1123.00 |
| ReziCure ™ 3026 | 104 | 50 | 50.48 | 31.95 | 2380.00 | 2381.50 |
| Metablen SX-006 | 0 | 15 | | 4.76 | 1182.40 | 1182.60 |
| Total | | | | 100.00 | 6533.60 | 6536.26 |
| % Bromine | | | 10.3% | | | |
| | | | | solids= | 57.01% | |
| 2-MI (20% NV in Dow PM) | | 20 | 0.047 | 0.030 | 5.50 | 5.00 |

### Results

Test results for Example 1 and the Comparative Example are given in Table 4.

TABLE 4

| | | Comparative | |
|---|---|---|---|
| Property | Units | Example | Example 1 |
| Laminate Thickness | mm | 1.6 | 1.48-1.66 |
| T_{g1} (10° C./minute) | ° C. | 171 | 169 |
| T_{g2} (10° C./minute) | ° C. | 173 | 170 |
| T_{g3} (20° C./minute) | ° C. | 180 | 174 |
| T_{d} (5% weight loss) | ° C. | 366 | 366 |
| Resin Content | % | 42.1 | 46 |
| T288 | minutes | 43.1 | 27 |
| CTE (<T_{g}) | ppm | 50.6 | 54 |
| CTE (>T_{g}) | ppm | 229.5 | 208.4 |
| Water Uptake | % | 0.3 | 0.3 |
| K_{1c} * | mPa m^{0.5} | 0.7 | 1.1 |
| T260 | minutes | >30 minutes | >30 minutes |
| Copper Peel Strength | lb_{f} per inch of width | 7.3 | 6.3 |

* K_{1c} data was obtained from the neat resin casting with the same composition.

Test results for Examples 2 and 3 are compared to the Comparative Example in Table 5.

TABLE 5

| Sample | Comp. Ex. | Example 2 | Example 3 |
|---|---|---|---|
| Laminate thickness | 1.6 | 1.44-1.60 | 1.40-1.56 |
| Tgl (10° C./min) | 171 | 170 | 170 |
| Tg2 (10° C./min) | 173 | 170 | 172 |
| Tg3 (20° C./min) | 180 | 174 | 176 |
| Td (5% wt. loss) | 363 | 371 | 367 |
| Resin content (%) | 42.1 | 44 | 43 |
| T288 (min) | 43.1 | >30 | >30 |
| CTE (<Tg ppm) | 50.6 | 60 | 53 |
| CTE (>Tg ppm) | 229.5 | 223 | 232 |
| Cu Peel (lb force/inch width) | 7.3 | 5.4 | 5.9 |
| Water Uptake (%) | 0.3 | 0.32 | 0.34 |
| Solder Dip @ 550 F. (% Pass) | 100 | 100 | 100 |
| Strain Energy Release | 0.230 | 0.560 | 0.542 |
| Rate, G_{1c} (kJ/m²) | | | |
| T260 (min) | >30 min | >30 min | >30 min |

Flammability test measurements (vertical burning test) are presented in Table 6.

TABLE 6

| | Example 2 | | Example 3 | | Comp. Ex. | |
|---|---|---|---|---|---|---|
| Specimen | l^{st} Burn | 2^{nd} Burn | l^{st} Burn | 2^{nd} Burn | l^{st} Burn | 2^{nd} Burn |
| Number | (s) | (s) | (s) | (s) | (s) | (s) |
| 1 | 0.6 | 3.1 | 0.4 | 6.7 | 0.7 | 2.0 |
| 2 | 0.9 | 4.6 | 0.5 | 6.2 | 0.9 | 3.3 |
| 3 | 0.9 | 1.1 | 0.5 | 7.9 | 1.1 | 2.5 |
| 4 | 0.9 | 0.7 | 0.7 | 3.6 | 0.8 | 3.9 |
| 5 | 0.5 | 3.3 | 0.7 | 3.3 | 2.5 | 3.9 |

| | | | |
|---|---|---|---|
| UL Rating | V-0 | V-0 | V-0 |

As described above, embodiments disclosed herein provide for curable compositions including epoxy resins and a core/shell rubber toughening agent. The resulting thermoset compositions may have dielectric properties suitable for use in high speed electronic parts, such as printed circuit boards.

While this invention has been described in detail for the purpose of illustration, it should not be construed as limited thereby but intended to cover all changes and modifications within the spirit and scope thereof.

What is claimed is:

1. A composition comprising:
an epoxy resin;
a curing agent; and
a silicone-acrylate core/shell rubber.

2. The composition of claim 1, wherein the composition comprises from 0.1 to 30 percent silicone/acrylate core/shell rubber by weight, based on a total weight of the curable composition.

3. The composition of claim 1, further comprising a brominated flame retardant.

4. The composition of claim 1, wherein the epoxy resin comprises at least one brominated epoxy resin.

5. A process comprising:
dispersing a silicone-acrylate core/shell rubber in a solvent;
admixing the dispersed silicone-acrylate core/shell rubber with an epoxy resin and one or more of a hardener, a catalyst, and additional solvent to form a curable composition.

6. The process of claim 5, further comprising admixing a brominated flame retardant with the curable composition.

7. The process of claim 5, wherein the epoxy resin comprises at least one brominated epoxy resin.

8. The process of claim 5, wherein the curable composition comprises from 0.1 to 30 percent silicone-acrylate core/shell rubber by weight, based on the total weight of the curable composition.

9. A varnish produced from the composition of claim 1.

10. An electrical laminate prepared from the varnish of claim 9.

11. A circuit board prepared from the varnish of claim 9.

12. A coating prepared from the varnish of claim 9.

13. A composite prepared from the varnish of claim 9.

14. A casting prepared from the varnish of claim 9.

15. An adhesive prepared from the varnish of claim 9.
